(19) United States
(12) Patent Application Publication
(10) Pub. No.: US 2025/0011957 A1
(43) Pub. Date: Jan. 9, 2025

(54) SYSTEMS AND METHODS FOR DIRECT LITHIUM EXTRACTION

(71) Applicant: ENERGY EXPLORATION TECHNOLOGIES, INC., Austin, TX (US)

(72) Inventors: Amit PATWARDHAN, Austin, TX (US); Teague M. EGAN, Austin, TX (US)

(73) Assignee: ENERGY EXPLORATION TECHNOLOGIES, INC., Austin, TX (US)

(21) Appl. No.: 18/710,799

(22) PCT Filed: Nov. 17, 2022
(86) PCT No.: PCT/US2022/080002

§ 371 Date: May 16, 2024

Related U.S. Application Data
(60) Provisional application No. 63/280,796, filed on Nov. 18, 2021.

(51) Int. Cl. C25C 1/02; C25C 7/04

(52) U.S. Cl. CPC C25C 1/02; C25C 7/04

(57) ABSTRACT

A direct lithium extraction (DLE) process and system comprising ion exchange, ion adsorption, and solvent extraction or other methods to reduce downstream process steps which typically include nanofiltration, reverse osmosis, mechanical-thermal evaporation, and additional solvent extraction or other steps.

This application claims the benefit of priority to U.S. Provisional Application No. 63/280,896, filed on Nov. 18, 2021, the entire contents of which are hereby incorporated by reference.

### TECHNICAL FIELD

The present disclosure relates to direct lithium extraction (“DLE”) technology. More specifically, the present disclosure relates to systems and methods for direct lithium extraction that combine one or more of ion exchange, ion sorption, solvent extraction, nanofiltration, reverse osmosis, mechanical thermal evaporation or other process steps, making it more economical by reducing the capital and operating costs, and reducing the carbon footprint of the operation.

### BACKGROUND OF THE INVENTION

In order to prevent the large environmental footprint of solar evaporation ponds, the evaporative loss of water in one of the world's most arid regions, achieve significantly higher lithium recovery from the resource, and utilize lower grade lithium resources, Direct Lithium Extraction (“DLE”) has gained significant interest. In addition, DLE promises to unlock the abundant low grade lithium resources found across the world. DLE involves pumping of the surface or subsurface brine and selective separation of Li from all other impurity cations using selective ion exchange, ion sorption, membrane separation, or solvent extraction and returning the lithium depleted brine to the brine pool. Due to the increasing focus on sustainability of lithium extraction “pure” DLE approach is an eventual certainty. In addition, it can effectively extract lithium from lower grade resources. Despite the advantages offered by DLE, there are several shortcomings. The separated Li concentration is too low (1000-3500 ppm) and still contains low level of impurities. Concentration of this brine to 15,000-60,000 ppm is required for its effective processing in the downstream processes. This is mainly accomplished by a series of cleaning and concentration steps which include nano filtration (“NF”) for divalent rejection and reverse osmosis (“RO”) and mechanical-thermal evaporation for lithium concentration as shown in the top of FIG. 1. This is followed by another step of solvent extraction for boron removal. The application of additional concentration by RO is limited by the Total Dissolved Solids (“TDS”) content of the brine and majority of lithium, and hence impurity concentration occurs using expensive mechanical thermal evaporation. All these steps add complexity and costs to the process which has been a major deterrent to the widespread adoption of DLE. All these processes are also energy intensive adding to the carbon dioxide footprint of the operation and reducing its sustainability.

Electrodialysis (“ED”) is a membrane process that is not limited by high TDS as is prevalent in lithium brines. In addition, it facilitates brine concentration simultaneously with impurity ion separation. ED allows ion separation under the influence of an applied electrical current. Under an electrical potential between the anode and the cathode, the positively charged cations migrate towards the cathode and the negatively charged anions move towards the anode. With monovalent or lithium selective membranes, only monovalent ions such as Na⁺, K⁺, Li⁺ or Li⁺ only can be transported across the membrane blocking the divalent and multivalent ions such as Ca₂₊ and Mg²⁺. In addition, boron transfer, which is another major impurity, is restricted.

Therefore, there remains a need to develop and enhance methods of separating lithium from brine solutions to obtain lithium that can be used in commercial applications such as battery manufacture.

### SUMMARY OF INVENTION

As identified above, typical DLE technologies utilize an ion exchange, ion adsorption, solvent extraction or other steps followed by multiple steps of nanofiltration, reverse osmosis and mechanical thermal evaporation. The disclosed invention combines one or more of the subsequent steps after the first one to reduce the number of required steps. This simplifies the process, makes it more economical by reducing the capital and operating costs and reduces the carbon dioxide footprint of operation.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present disclosure. The invention may be better understood by reference to one of these drawings in combination with the detailed description of specific embodiments presented herein.

FIG. 1 shows typical DLE Block Flow Diagram using multiple capital and energy intensive steps on the top. The present disclosure process simplifying the process with a single step of selective membrane electrodialysis is shown on the bottom.

FIG. 2 shows the schematic of test setup for testing LiTAS™ membranes on DLE brines. The ED Stack represented here shows a single cell pair. Testing is conducted in stacks of 10-40 cell pairs.

FIG. 3 shows the flow balance of (FIG. 3A) reverse osmosis system treating supplied eluate followed by (FIG. 3B) electrodialysis.

FIG. 4 shows the schematic of a selective electrodialysis process where CIMS is a selective cation exchange membrane and ACS is an anion selective membrane.

### DETAILED DESCRIPTION OF EMBODIMENTS

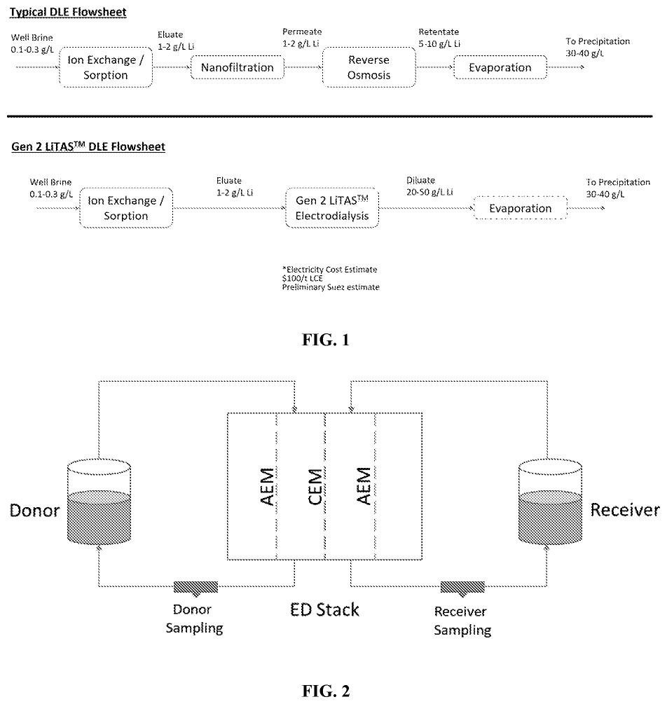

The disclosed invention combines the multiple steps of NF, RO, and evaporation after the first separation step into a single step using selective membrane electrodialysis to simultaneously clean and concentrate the brine to the desired level (FIG. 1, bottom). This simplifies the process, reduces the capital and operating costs and reduces the CO₂ footprint of operation. It also eliminates installation of large pieces of equipment like the evaporator at remote locations where lithium is mined.

Adoption of DLE is impeded today by the high capital and operating costs along with the energy intensive mechanical evaporation required at remote locations where lithium is found. The disclosed invention addresses these issues while significantly simplifying the process. The proposed method reduces capital and operating costs of DLE by 25-30% unlocking utilization of multiple low grade sources of lithium across the world.

The present methods describe the use of an electrodialysis process to clean or purify a brine solution. These and more detailed parts are described in more detail below.

### I. Selective Electrodialysis

Selective electrodialysis is a process in which ions move through ion selective membranes under an applied electric potential. The electrodialysis cell is characterized by a positively charged anode and a negatively charged cathode between which current flows under an applied electric potential. Adjacent to the anode and the cathode is a chamber created by introducing a cation exchange end membranes through which the electrode rinse solution circulates. Between the two end membranes there is a series of alternating anion exchange membranes and cation exchange membranes. The anion exchange membranes have fixed positive charge groups that prevent the positively charged cations from passing through while allowing the negatively charged anions to pass in the direction of the positively charged anode. The cation exchange membranes have fixed negative charge groups that prevent the negatively charged anions from passing through while allowing the positively charged cations to pass in the direction of the negatively charged cathode. These methods may be applied to a lithium brine solution that has been pre-treated. The lithium brine may be subjected to ion exchange, ion absorption, or solvent extraction before exposing the lithium brine to the electrodialysis methods described herein. These methods may then result in a method that is substantially improved compared to the prior art method in that it requires fewer purification steps or techniques to achieve a final product. The electrodialysis methods described herein may be coupled with one or more pre-treatment steps and/or one or more post-treatment steps. These pre- and post-treatment steps include reverse osmosis, mechanical thermal evaporation, ion exchange, solvent extraction, nanofiltration, or whole salt adsorption. These methods may result in a solution with increased purity, increased lithium concentration, or both. In particular, the lithium concentration may be increased from 1%, 2%, 3%, 4%, 5%, 10%, 20%, 30%, 40%, 50%, 75%, 100%, 125%, 150%, 175%, 200%, 250%, 300%, 400%, 500%, or more.

In some aspects, the present method describe the use of one or more membranes. The membranes may be selective for one or more types of ions, for example, anions or cations. The membranes may also be selective for other things such as size, amount of charge, or ionic size. In one embodiment, the membrane is selected for a monovalent over a multivalent anion, a multivalent over a monovalent anion, a monovalent over a multivalent cation, or a multivalent over a monovalent cation. These membranes may be present in an electrodialysis stack that contains from about 2 membranes to about 1,500 membranes, from about 5 membranes to about 1,250 membranes, from about 100 membranes to about 1,000 membranes, or from about 200 membranes to about 750 membranes. The membranes may be from about 2, 5, 7, 10, 12, 15, 20, 30, 40, 50, 75, 100, 150, 200, 300, 400, 500, 600, 700, 750, 800, 900, 1,000, 1,100, 1,200, 1,250, 1,300, 1,400, to about 1,500 membranes, or any range derivable therein. These membranes may be stored in a chamber that is located between the electrodes in the electrodialysis chamber. The membranes used in these methods may have an effective error from about 0.1 m²/membrane to about 1.5 m²/membrane, from about 0.25 m²/membrane to about 1.25 m²/membrane, or from about 0.5 m²/membrane to about 1.1 m²/membrane. The effective area may be from about 0.1 m²/membrane, 0.2 m²/membrane, 0.25 m²/membrane, 0.3 m²/membrane, 0.4 m²/membrane, 0.5 m²/membrane, 0.6 m²/membrane, 0.7 m²/membrane, 0.75 m²/membrane, 0.8 m²/membrane, 0.9 m²/membrane, 1.0 m²/membrane, 1.1 m²/membrane, 1.2 m²/membrane, 1.25 m²/membrane, 1.3 m²/membrane, 1.4 m²/membrane, to about 1.5 m²/membrane, or any range derivable therein.

The methods used herein comprise using a current to separate the lithium ions. The current applied may have a current from about 1.5 A to about 750 A, from about 2 A to about 500 A. The current may be from about 1 A, 1.5 A, 2 A, 3 A, 4 A, 5 A, 7.5 A, 10 A, 20 A, 30 A, 40 A, 50 A, 75 A, 100 A, 125 A, 150 A, 175 A, 200 A, 250 A, 300 A, 350 A, 400 A, 450 A, 500 A, 550 A, 600 A, 650 A, 700 A, 750 A, to about 800 A, or any range derivable therein. These methods can apply a current density to the brine. The current density is from about 5 A/m² to about 500 A/m² or from about 10 A/cm² to about 250 A/cm². The current density may be from about 5 A/cm², 10 A/cm², 20 A/cm², 30 A/cm², 40 A/cm², 50 A/cm², 60 A/cm², 70 A/cm², 75 A/cm², 80 A/cm², 90 A/cm², 100 A/cm², 125 A/cm², 150 A/cm², 175 A/cm², 200 A/cm², 225 A/cm², 250 A/cm², 275 A/cm², 300 A/cm², 350 A/cm², 400 A/cm², 450 A/cm², to about 500 A/cm², or any range derivable therein.

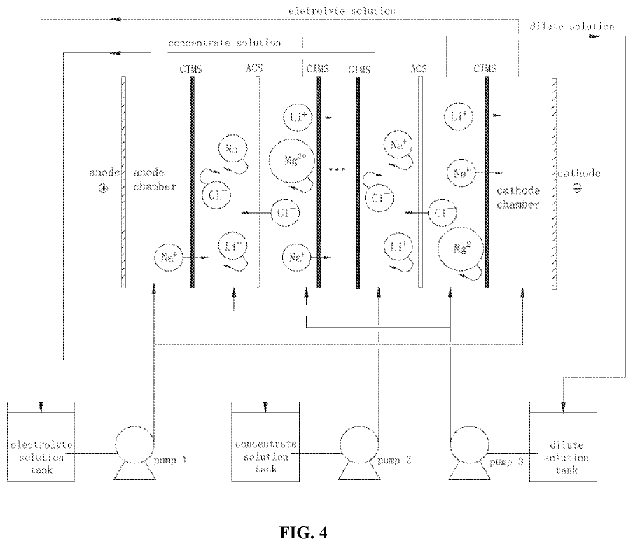

As shown in FIG. 4, an aqueous feed (dilute) containing a mixture of anions and cations is introduced in between the chambers created by the alternating anion and cation and anion exchange membranes. The cations pass through the cation exchange membrane to the adjacent concentrate chamber towards the cathode. The anions in the feed (dilute) pass through the anion exchange membrane to the other adjacent concentrate chamber towards the anode. All dilute and concentrate chambers are combined separately. This way, the feed is depleted of the ions which concentrate in the concentrate stream.

When the cation exchange membranes are monovalent selective, divalent impurity ions such as Mg²⁺ are left behind in the feed while only monovalent ions like Lit migrate to the concentrate. With monovalent selective anion exchange membranes, similar separation between monovalent and divalent anions like Cl⁻ and SO₄²⁻ is possible. Thus, selective electrodialysis as applied in this invention can simultaneously clean and concentrate lithium brines.

In some aspects, the electrodialysis methods described herein further comprises one or more pre-treatment steps. These pre-treatment steps include reverse osmosis, mechanical thermal evaporation, ion exchange, solvent extraction, nanofiltration, or ion absorption. In some aspects, the electrodialysis methods described herein further comprises one or more post-treatment steps. These post-treatment step include reverse osmosis, mechanical thermal evaporation, ion exchange, solvent extraction, nanofiltration, or ion absorption. These methods described herein may further comprise one or more of these steps in addition to the electrodialysis methods using a selective membrane described herein.

### II. Lithium and Lithium Brines

Lithium is widely used for many industrial applications including lithium-ion batteries, glasses, greases, and other applications such as metallurgy, pharmaceutical industry, primary aluminum production, organic synthesis, etc. Lithium mining has drawn significant interest due to the recent surge in electrical vehicle (“EV”) market and its increasing forecast. Lithium-ion batteries have so far demonstrated highest energy density and stability for automobile applications. Lithium production is expected to triple between 2021 and 2025 due to the projected growth in EV mobility and grid storage. Most lithium production in past and recent years has been from the so-called lithium triangle comprising the convergence of Chile, Argentina, and Bolivia in South America. Even though the newer production has been coming from hard-rock sources such as spodumene in Western Australia, the dominance of brine-based production is expected to continue into the foreseeable future. In 10-20 years, recycling of lithium from spent batteries is expected to supplant new production.

More than two-thirds of the lithium resources in the world reside in the lithium triangle (region around the intersection of the countries of Argentina, Bolivia and Chile). These very high salinity brines contain lithium concentrations ranging from 200 ppm-2000 ppm. Lithium in these brines is associated with high levels of Na⁺, K⁺, Mg²⁺, Cl⁻, SO₄²⁻, B (ionic or molecular) and other ions. In addition, other salt lake resources exist in China, Israel, Jordan, Ethiopia, Tunisia, and Mongolia. There are also commercially exploited resources of subsurface continental brines, such as in Clayton Valley, Nevada, USA (100-300 ppm Li) which are processed in the same fashion as the salt lake brines described below. Lithium has been additionally found in somewhat lower concentrations (30-80 ppm Li) in other surface brines such as the Great Salt Lake in Utah, USA. At low concentrations (30-300 ppm, but mostly in the 30-150 ppm Li range), lithium is found in a variety of locations across the world as subsurface brines. Lithium is also present in low but reasonable (30-300 ppm Li) quantities in produced water from oil and gas drilling activities. Most geothermal brines also contain elevated levels of Li (100-500 ppm) and are found across the world. In the USA, the Salton Sea area in California is of prime interest for lithium extraction from geothermal brines. Geothermal brines are also of significant interest in the UK, France, Germany Russia and Italy.

Lithium recovery from salt lake brine is a long process that involves drilling in order to access the sub surface brine deposits, pumping brine to the surface, and brine distribution to solar evaporation ponds where the brine is concentrated for 18-24 months. During the solar evaporation stage, sodium, potassium and magnesium chloride salts precipitate before lithium precipitation losses begin. Lithium concentration nevertheless continues to increase sacrificing 40-70% of the contained lithium as a co-precipitate mixed with other less valuable salts. The final concentrated lithium brine is then processed through a series of separation steps involving solvent extraction for boron removal, lime-soda softening for Mg, Ca and heavy metal impurity removal followed by precipitation with soda ash as lithium carbonate. The crude lithium carbonate is further refined to battery grade or converted to a battery grade lithium hydroxide monohydrate product again involving additional processing steps. A majority of the world's lithium carbonate and hydroxide is produced in this fashion.

All of these brines may contain impurities that need to be removed before the lithium in the brine can be used for commercial applications such as the production of batteries. The impurities may be magnesium ions, calcium ions, sodium ions, potassium ions, arsenic ions, boron ions, sulfate ions, silicon ions, or chloride ions. The methods described herein may result in the rejection, or elimination, of one or more of these impurities. The rejection may be at least 50%, 55%, 60%, 65%, 70%, 75%, 80%, 85%, 90%, 92.5%, 95%, 96%, 97%, 98%, 99%, 99.5%, 99.75%, or 99.9% of one or more types of these impurities. The process may remove only one of these impurities, a group of them, or all of the impurities. In some embodiments of these methods, 1, 2, 3, 4, 5, 6, 7, 8, or 9 impurities may be removed. In some cases, the amount of the impurity removed from the lithium brine solution is from about 50% to about 99.9%, from about 55% to about 98%, or from about 60% to about 95%. In some embodiments, the amount of impurities that are removed are from 40%, 45%, 50%, 55%, 60%, 65%, 70%, 75%, 80%, 85%, 90%, 92.5%, 95%, 96%, 97%, 98%, 99%, 99.5%, 99.75%, to about 99.9%, or any range derivable therein of one or more types of these impurities.

These types of brines maybe used in the methods and systems described herein. In particular, the present disclosure comprises using one of these solutions in the methods and returning a solution that is substantially increased in lithium concentration to use to produce battery grade lithium.

### III. Examples

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Testing Method

Testing was conducted in a full recycle mode as shown below in FIG. 2. Donor solution was the brine. Starting Receiver solution was slightly acidified water to provide initial conductivity. Experimental parameters were recorded during the testing, including applied voltage, current, pressure, electrical conductivity, temperature, pH, and weights of Donor and Receiver. Samples of Donor and Receiver were collected at the beginning of the test. After current was applied, samples of both Donor and Receiver were collected at certain time intervals based on the duration of the test. The samples were analyzed for Li, Na, K, Ca, Mg, B, Cl and SO₄.

### Example 1

A chloride brine at pH of 1.5 containing 3,000 ppm Li obtained after an ion exchange separation process was subjected to selective membrane electrodialysis. Testing was conducted in the manner shown in FIG. 2 with a standard MK1 Electrodialysis stacks supplied by Suez Water Technology Solutions Inc. The stack results are scalable up to commercial scale. A donor (feed) to starting receiver (product) ratio of 5:1 was set. EnergyX's LiTAS™ selective electrodialysis membranes were used. Ten (10) cell pairs with an effective area of 0.0278 m²/membrane was used. Initial current was set at 7.5 A which corresponds to a current density of 27 mA/cm². The starting voltage was recorded at 13V. As, the ions transferred from the donor to receiver and the donor was depleted, its conductivity reduced as expected and resistance increased. As a result, the voltage increased to 21V (maximum safe operating voltage for these conditions) and current dropped to 4.4 A. Along with ion transfer, the expected electro-osmotic water transfer was observed from donor to receiver. Samples were collected at different time intervals and analyzed for Li, Ca and Mg. Low levels of Na and K were present which were not analyzed.

The desired concentration of 15,000 ppm Li was realized in a single step along with a reduction in impurities (Table 1) thus allowing replacement of multi-stage cleaning and concentration steps from the flowsheet. The target concentration is determined by the requirement to feed a direct to lithium hydroxide electrodialysis process. The remainder of lithium can be recycled to the front of the process increasing the overall concentration of the feed which may offer additional advantages. The reduction in Lithium concentration with time is a result of batch mode testing and will not be observed in continuous operation. In batch mode, as Li is depleted from the donor the transfer of lithium becomes more difficult.

TABLE 1
Selective membrane electrodialysis treatment of ion
exchange Li separated brine embodying the invention.

| | | | | | | | Product |
|---|---|---|---|---|---|---|---|
| | Li | Ca | Mg | Li/Mg | Li/Ca | Li Flux | Lithium |
| Time | Recovery | Rejection | Rejection | Selectivity | Selectivity | (g | Concentration |
| (hr) | (%) | (%) | (%) | (RTN) | (RTN) | Li/m²/h) | (ppmw) |
| 0 | — | — | — | — | — | — | 2909* |
| 0.3 | 9% | 94% | 98% | 1.3 | 4.2 | 69.8 | 14553 |
| 1.0 | 30% | 91% | 94% | 3.8 | 5.0 | 78.0 | 15206 |
| 1.5 | 42% | 91% | 89% | 5.8 | 3.6 | 73.0 | 11274 |
| 2.0 | 53% | 88% | 82% | 6.9 | 3.2 | 69.8 | 12511 |

*Starting Feed Li concentration.

Another test was conducted on this brine with a Donor to Receiver ratio of 8:1. Initial current was set at 7.5 A. The starting voltage was recorded at 13V. As, the ions transferred from the donor to receiver and the donor was depleted, voltage increased to 18V to maintain the current at the set 7.5 A. Results achieved are shown in Table 2. Again, the target Lithium concentration was realized.

TABLE 2
Another test using selective membrane electrodialysis treatment
of ion exchange Li separated brine embodying the invention.

| | | | | | | | Product |
|---|---|---|---|---|---|---|---|
| | Li | Ca | Mg | Li/Mg | Li/Ca | Li Flux | Lithium |
| Time | Recovery | Rejection | Rejection | Selectivity | Selectivity | (g | Concentration |
| (hr) | (%) | (%) | (%) | (RTN) | (RTN) | Li/m²/h) | (ppmw) |
| 0 | — | — | — | — | — | — | 2561* |
| 0.3 | 8% | 97% | 97% | 2.6 | 2.4 | 83.2 | 14862 |
| 1.0 | 17% | 96% | 94% | 4.5 | 2.6 | 88.9 | 14799 |
| 1.5 | 26% | 95% | 91% | 5.7 | 3.0 | 81.2 | 14966 |
| 2.0 | 33% | 94% | 89% | 6.0 | 3.2 | 86.0 | 12629 |
| 2.5 | 52% | 88% | 81% | 5.4 | 2.9 | 107.5 | 8071 |

*Starting Feed Li concentration.

### Example 2

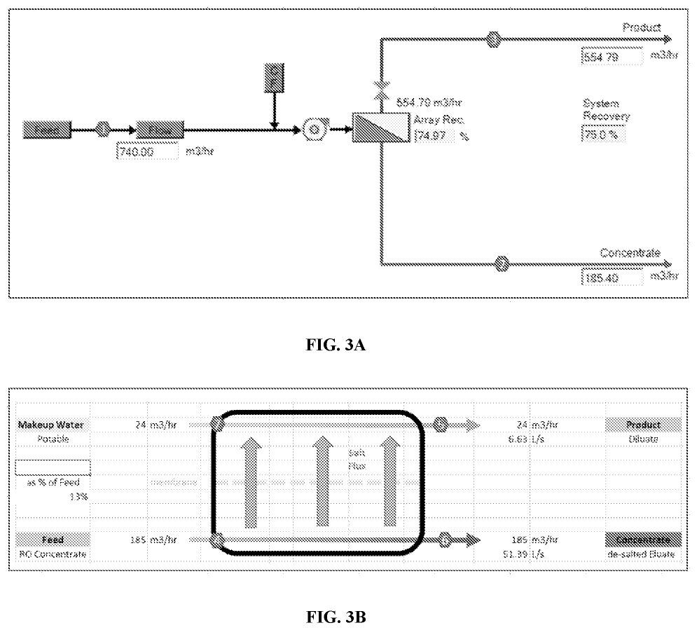

In another embodiment, the target lithium concentration was greater than 35,000 ppm Li to feed a downstream lithium carbonate plant. The source brine after ion adsorption and elution only contained 1200 ppm of Li. In this case, the flowsheet was simplified eliminate NF and evaporation as indicated in FIG. 3. The feed went through a pre-concentration step of RO to concentrate the lithium content nearly 4 fold to 4800 ppm Li. This was followed by selective membrane electrodialysis to achieve 35,000 ppm Li concentration. Greater than 90% rejection of all impurities was realized as shown in Table 3.

Detailed capital expenditure and operational expenditure comparisons were conducted for this embodiment which indicated a capital and operating cost reduction of the system after the first ion adsorption step by 50% or more.

TABLE 3
Summary feed and concentrate qualities and impurity rejections from
the proposed LiTAS ™ membrane electrodialysis process.

| | Feed | Concentrate | Rejection |
|---|---|---|---|
| Li (mg/L) | 1200 | 35138 | 5% |
| Mg (mg/L) | 20 | 20 | 97% |
| Ca (mg/L) | 10 | 10 | 97% |
| Na (mg/L) | 1000 | 1942 | 94% |
| K (mg/L) | 30 | 58 | 94% |
| As (mg/L) | 5 | 2 | 99% |
| B (mg/L) | 100 | 100 | 99% |
| SO₄ (mg/L) | 20 | 49 | 92% |
| Si (mg/L) | 8 | 2 | 99% |
| Cl (mg/L) | 8000 | 182798 | 26% |

### Example 3

In this embodiment treating a geothermal brine source at nearly 2120 ppm Li, concentration to 35,000 ppm Li was indicated using only selective membrane electrodialysis after ion exchange. The feed and product results are shown in Table 4 along with the achieved rejection of impurity ions. The electricity consumption for this process was only $65/ton of lithium carbonate equivalent (LCE). The capital cost of the system was only $6 million for producing 8000 tons of LCE per year. The operating cost for a baseline evaporator system would be 10 fold. The capital cost of an evaporator performing the same concentration duty would be $70 million. Hence significant capital expenditure and operating expenditure savings are realized.

TABLE 4
Performance of the invention embodiment using only selective
membrane electrodialysis after ion exchange for a geothermal brine.

| | Feed | Recycle | Product | Recovery |
|---|---|---|---|---|
| Flow Rate (mass | 85 | 80.1 | 1.4 | — |
| units) | | | | |
| Li (ppmw) | 2120 | 112 | 35087 | 95% |
| Na (ppmw) | 235 | 12 | 3889 | 95% |
| K (ppmw) | 104 | 6 | 1721 | 95% |
| Mg (ppmw) | 5 | 885 | 12 | 14% |
| Ca (ppmw) | 965 | 5 | 2282 | 14% |
| B (ppmw) | 7 | 7 | 7 | 6% |

### Example 4

In this embodiment, the first separation stage is solvent extraction separating Li out of an Argentinian brine containing 700 ppm Li. After solvent extraction, the product is at 6700 ppm Li. Another embodiment here is operation of membrane electrodialysis at moderate recoveries recycling the remainder back to the solvent extractant system which increases the feed concentration to the system making it more efficient without adding any capital or operating costs as the solvent is circulated underutilized at low concentrations of feed. The result of this operation is presented in Table 5.

TABLE 5
Performance of the invention embodiment on a solvent extraction product
using moderate lithium recovery with recycle and using only non-selective
ion exchange membranes for concentration using electrodialysis.

| | Feed | Recycle | Product |
|---|---|---|---|
| Li (ppmw) | 6680 | 3543 | 58188 |
| Na (ppmw) | 4140 | 2196 | 36063 |
| K (ppmw) | 0 | 0 | 0 |
| Mg (ppmw) | 0 | 0 | 0 |
| Ca (ppmw) | 100 | 53 | 871 |
| B (ppmw) | 0 | 0 | 0 |
| SO₄ (ppm) | 20 | 11 | 174 |

The same process could also be applied for concentration after pre-evaporation (or forced evaporation) of the brine in one or more additional ponds. Starting from a brine concentration of 2400 ppm Li after pond evaporation, the electrodialysis concentration yields a product at maximum concentration even operating at low recoveries with recycle (Table 6).

TABLE 6
Performance of the invention embodiment on a solvent extraction product
after preconcentration using evaporation ponds using moderate lithium
recovery with recycle and using only non-selective ion exchange
membranes for concentration using electrodialysis.

| | Feed | Recycle | Product |
|---|---|---|---|
| Li (ppmw) | 10170 | 7229 | 58469 |
| Na (ppmw) | 5590 | 3973 | 32138 |
| K (ppmw) | 20 | 14 | 115 |
| Mg (ppmw) | 0 | 0 | 0 |
| Ca (ppmw) | 100 | 71 | 575 |
| B (ppmw) | 0 | 0 | 0 |
| SO₄ (ppm) | 30 | 16 | 261 |

All of the systems and methods disclosed and claimed herein can be made and executed without undue experimentation in light of the present disclosure. While the systems and methods of this disclosure have been described in terms of preferred embodiments, it will be apparent to those of skill in the art that variations may be applied to the systems and methods, as well as in the steps or in the sequence of steps of the method described herein without departing from the concept, spirit, and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

1. A method of preparing a purified lithium brine solution comprising:
(A) obtaining a brine solution containing a first concentration of lithium; wherein the brine solution has been subjected to a prior purification step; wherein the prior purification step is ion exchange, ion adsorption, or solvent extraction and the brine solution contains a concentration of multivalent ions of greater than 5 ppm;
(B) exposing the brine solution to an electrodialysis stack; wherein the electrodialysis stack comprises one or more membranes; and
(C) obtaining a purified lithium brine solution wherein the concentration of lithium in the purified lithium brine solution is increased by at least 0.1% than the first concentration of lithium.

2. (canceled)

3. The method of either claim 1, wherein the purified lithium brine solution has a concentration of lithium twice as high as the first concentration of lithium.

4.-5.

6. The method of claim 1, wherein the membrane is an anion selective membrane.

7. The method of claim 6, wherein the anion selective membrane allows for the passage of monovalent anions over multivalent anions.

8. (canceled)

9. The method of claim 1, wherein the membrane is a cation selective membrane.

10. The method of claim 9, wherein the cation selective membrane allows for the passage of monovalent cations over multivalent cations.

11. (canceled)

12. The method of claim 1, wherein the electrodialysis stack comprises from 2 membranes to 1500 membranes.

13.-15. (canceled)

16. The method of claim 1, wherein the electrodialysis stack comprises a chamber between the one or more membranes and an electrode.

17. The method of claim 16, wherein the electrodialysis stack comprises a cathode chamber between a cathode and the one or more membranes.

18. The method of claim 16, wherein electrodialysis stack comprises an anode chamber between an anode and the one or more membranes.

19. The method of claim 1 further comprising applying a current to the electrodialysis stack from about 1.5 A to about 750 A.

20. (canceled)

21. The method of claim 1, wherein each membrane has an effective area from about 0.1 m²/membrane to about 1.5 m²/membrane.

22.-23. (canceled)

24. The method of claim 1, wherein the method further comprises applying a voltage potential to the brine solution.

25.-26. (canceled)

27. The method of claim 1,
wherein the method further comprises an inlet feed and an outlet feed for the brine solution and the purified and concentrated brine solution.

28. The method of claim 27, wherein the method comprises a ratio of brine solution coming in the inlet feed to the amount of the purified brine solution going out in the outlet feed from about 1:1 to about 200:1.

29.-30. (canceled)

31. The method of claim 1, wherein the method results in the rejection of at least 50% of one impurity.

32.-40. (canceled)

41. The method of claim 31, wherein the method results in the rejection of at least 6050% of one or more impurities.

42.-44. (canceled)

45. The method of claim 31, wherein the method results in the rejection of from about 50% to about 99.9% of one or more impurities.

46.-50. (canceled)

51. The method of claim 1, wherein the method further comprises one or more post-treatment steps.

52. (canceled)

53. The method of claim 1, wherein the method results in a decrease in multivalent ion concentration of at least 0.1%.

54. The method of claim 9, wherein the cation selective membrane allows for the passage of lithium ions.
